(19) United States
(12) Patent Application Publication
(10) Pub. No.: US 2022/0012102 A1
(43) Pub. Date: Jan. 13, 2022

(54) HIGHLY SCALABLE, PEER-BASED, REAL-TIME AGENT ARCHITECTURE

(71) Applicant: Calgary Scientific Inc, Calgary (CA)

(72) Inventors: Christopher James Jarabek, Calgary (CA); Matthew James Stephure, Toronto (CA); Kevin Viggers, Calgary (CA); Ashit Ashvinkumar Vyas, Calgary (CA); Lucas Amaral Lopes, Calgary (CA); Owen James Wright, Cochrane (CA); Jacek Wielebnowski, Calgary (CA); Matthew James Louis Crist, Calgary (CA); Joshua Sung-Ryoung Hong, Calgary (CA); Chung Tai Lai, Seattle, WA (US)

(21) Appl. No.: 17/369,290

(22) Filed: Jul. 7, 2021

Related U.S. Application Data
(60) Provisional application No. 63/049,066, filed on Jul. 7, 2020.
(60) Provisional application No. 63/116,990, filed on Nov. 23, 2020.

(51) Int. Cl. G06F 9/50; G06F 9/355; G06F 9/455; G06F 9/38

(52) U.S. Cl. CPC G06F 9/5072; G06F 9/5027; G06F 2009/4557; G06F 9/45558; G06F 9/3851; G06F 9/3555

(57) ABSTRACT

A system architecture that synthesizes agent environments and virtualization environments to provide for a highly scalable, peer-to-peer real-time agent architecture. The agent environment enables agents participating in a shared experience to be peers of one another. Agents can choose which agents they want to peer by meeting in the agent environment and using published information determine which other agents they want to peer with to communicate stream source data therebetween. Virtualization environments are a mechanism for executing applications (“stream sources”). Any one or more of available virtualization environments (e.g., cloud infrastructure) may be selected in accordance with predetermined criteria to execute stream sources. In addition, non-virtualized environments (e.g., physical devices) may be utilized to run the stream sources in accordance with deployment criteria. As such, processes may be run over a large number of possibly different environments to provide novel end-user solutions and greater scaling of resources.

### CROSS-REFERENCE TO RELATED APPLICATION

This application claims priority U.S. Provisional Patent Application No. 63/049,066, filed Jul. 7, 2020, entitled, “HIGHLY SCALABLE, PEER-BASED, REAL-TIME INTERACTIVE REMOTE ACCESS ARCHITECTURE” and U.S. Provisional Patent Application No. 63/116,990, filed Nov. 23, 2020, entitled, “HIGHLY SCALABLE, PEER-BASED, REAL-TIME INTERACTIVE REMOTE ACCESS ARCHITECTURE,” each of which is incorporated herein by reference in its entirety.

### BACKGROUND

Historically, in order to achieve acceptable interactivity in multi-client environments, it can be necessary to use proprietary protocols, and to tightly couple the client and backend streaming resources, which limits the ability of the cloud-computing environment to scale. Additionally, when building solutions which integrate a variety of disparate data and systems, this integration often requires the presence of a streaming application.

### SUMMARY

The present disclosure provides a description of a system architecture that synthesizes agent environments and virtualization environments to provide for a highly scalable, peer-to-peer real-time agent architecture. The agent environment enables agents participating in a shared experience to be peers of one another. Agents can choose which agents they want to peer with by meeting in the agent environment and using published information to determine which other agents they want to peer with to communicate stream source data therebetween. The peered agents may also communicate messages and event information over the peer-to-peer connection. Virtualization environments are a mechanism for executing applications (as “stream sources”). As will be described below, any one or more of available virtualization environments (e.g., cloud infrastructure) may be selected in accordance with predetermined criteria to execute stream sources. In addition, non-virtualized environments (e.g., physical devices) may be utilized to run the stream sources in accordance with deployment criteria. As such, processes may be run over a large number of possibly different environments to provide novel end-user solutions and greater scaling of resources.

In accordance with an aspect of the disclosure, a platform for providing scalable, peer-to-peer based data synchronization is disclosed. The platform utilizes a platform API through which all interactions with the platform flow and are authenticated. A console is to which clients connect through the platform API is provided to interact with the platform. An application repository stores stream sources and descriptors, where the descriptors provide information about how to run the steam sources in disparate virtualization environments. An agent environment provides a mechanism for one or more agents to determine from published information about other agents, which of the other agents the one or more agents want to peer with to communicate stream source data therebetween using peer-to-peer connections. The platform communicates to one or more virtualization providers that are responsible for computing infrastructure within the disparate virtualization environments to scale resources in accordance with requirements of the stream sources.

In accordance with another aspect of the disclosure, a scalable, peer-to-peer based agent architecture is disclosed. The architecture includes a platform that interfaces to external entities using a platform API, the platform including an application repository that stores stream sources and associated descriptors, an agent environment and a developer console; and a virtualization environment that executes stream sources to produce output data. Virtualization providers register the virtualization environments with the platform. The stream sources and associated descriptors are replicated from the platform to the virtualization environment. One or more agents connect to the agent environment and use published information about other agents to determine which of the other agents the one or more agents want to peer with. Peered agents communicate the output data therebetween using a peer-to-peer connection.

In accordance with another aspect of the disclosure a method for providing scalable, peer-to-peer based streaming between agents is disclosed. The method includes receiving a stream source uploaded to a console of a platform from an authenticated user; saving the stream source to an application repository together with descriptor information associated with the stream source; provisioning the stream source by replicating the stream source and descriptor information to at least one virtualization environment specified by the descriptor information and registered with the platform by an associated virtualization provider; subsequently, receiving a request at the platform to launch the stream source; executing a first process in the at least one virtualization environment to run the stream source; executing a second process in the at least one virtualization environment to run an agent associated with the stream source; and streaming data from the agent to a second agent over a peer-to-peer connection to exchange data and messaging therebetween.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A illustrates components that facilitate the uploading of a stream source within an architecture in accordance with the present disclosure;

FIG. 1B illustrates components that facilitate the execution of a stream source in a runtime environment within the architecture;

FIG. 2 illustrates the platform of FIGS. 1A and 1B in greater detail;

FIGS. 3 and 4 illustrates virtualization environments for scheduled deployment requests and on-demand deployments within the architecture of FIGS. 1A and 1B;

FIG. 5 illustrates processes performed in uploading a stream source;

FIG. 6 illustrates processes performed when launching a stream source and a streaming agent that is registered to platform; and

FIG. 7 illustrates an example wherein the virtualization environment is within an on-premises data center.

### DETAILED DESCRIPTION

### Introduction

The system architecture described herein solves many limitations in the art, including, but not limited to, how to provide protocol agnostic, real-time interactive services, at scale, in a way that allows for those services to be easily connected to third party applications, services and data; how to provide self-service facilities for end users to upload and publish stream sources in a globally distributed fault-tolerant way; and how to dynamically manage and optimize infrastructure costs and availability in a multi-tenant platform. To achieve the above, the present disclosure describes an architecture that synthesizes agent environments and virtualization environments to provide for a highly scalable, peer-to-peer real-time agent architecture. Agent environments are a common reference point around which agents can coordinate their activity. Similar to a physical meeting room that may house participants and materials associated with a meeting, the agent environment provides services to enable the agents to achieve any number of collaborative scenarios and with bidirectional data flows. Agents use published information within the agent environments to determine which other agents they want to peer with. Once agents are peered, secure data synchronization and service integration between the peered agents takes place.

Virtualization environments are mechanism for executing “stream sources.” Herein, a “stream source” may be any executable program, such as a desktop program, game, or other application that can produce a supported video stream and that may optionally accept and respond to standardized remote interaction events. The stream source(s) may be trusted or untrusted executables. In accordance with a feature of the present disclosure, any available virtualization environment may be selected in accordance with predetermined criteria to execute the stream sources. These include, but are not limited to, cloud-based environments, on-premises, private data centers, desktop or laptop computers, smart phones, appliances, IoT devices, or other devices that create digital twins (e.g., a representation of multiple systems that can bidirectionally send and receive data in real-time). This advantageously advances the state of the art by enabling one or more possibly disparate environments to be dynamically selected in order to maximize server utilization, maximize streaming performance, minimize cost, minimize latency, etc. As such, rendering (or other) processes may be run over a number of different virtualized or non-virtualized environments.

As will be described below, the architecture as a whole addresses problems of scaling of resources needed to execute streaming applications, and being extensible in a number of different directions to include other types of applications and disparate resources. In one aspect, the connection model is shifted from having remote browser based clients connect to centralized cloud-based streaming services, to a new paradigm where the browsers, stream sources, and any other services and data sources connect to one another through a peered agent-based relationship. In this paradigm, rendering processes, browser based web clients, and other data integration sources are all peers in an agent environment, which facilitates the sharing of data, be it 3D streaming video, basic data synchronization, or IoT data, etc.

An example technical effect of the system architecture of the present disclosure is a system where a game or other applications (i.e., a stream source) are published in a variety of ways into a fully managed cloud platform, and deploy/publish those stream sources into a variety of highly-available virtualization environments, be they on Amazon Web Services (AWS), Google Cloud Platform (GCP), Azure or other non-virtualized computational runtime environments. Users can create stream sources without a need to know any of the underlying details of the virtualization environments. For example, a user may deploy their stream source by specifying details such as streaming framerate, time to first frame, network latency or cost, and then the platform chooses a virtualization provider of one or more virtualization environments that best fits the user's criteria. Once deployed, the stream sources and associated agents communicate in an authenticated and secure way with other agents providing data and services to each other, be it non-visual, binary, textual data, or streaming video data.

Architecture Description

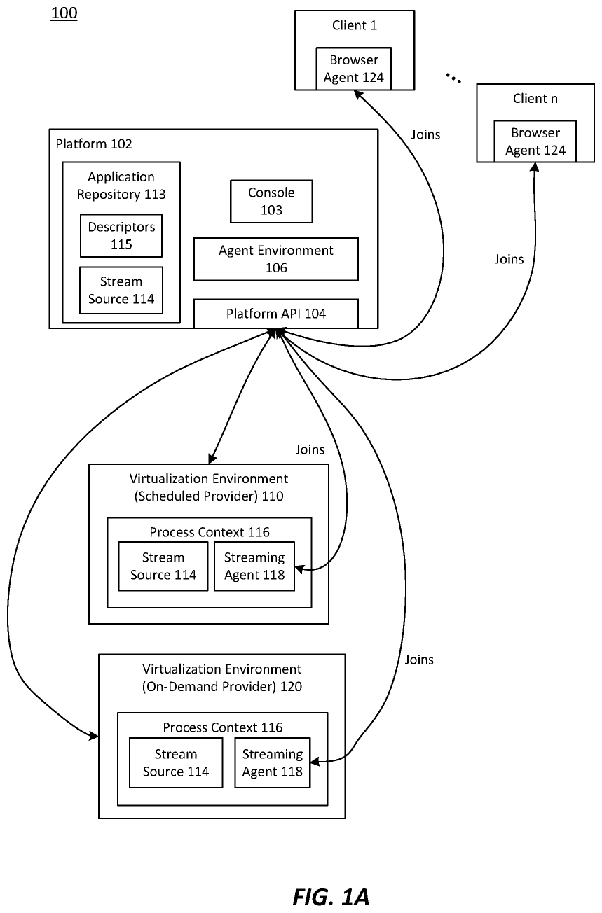

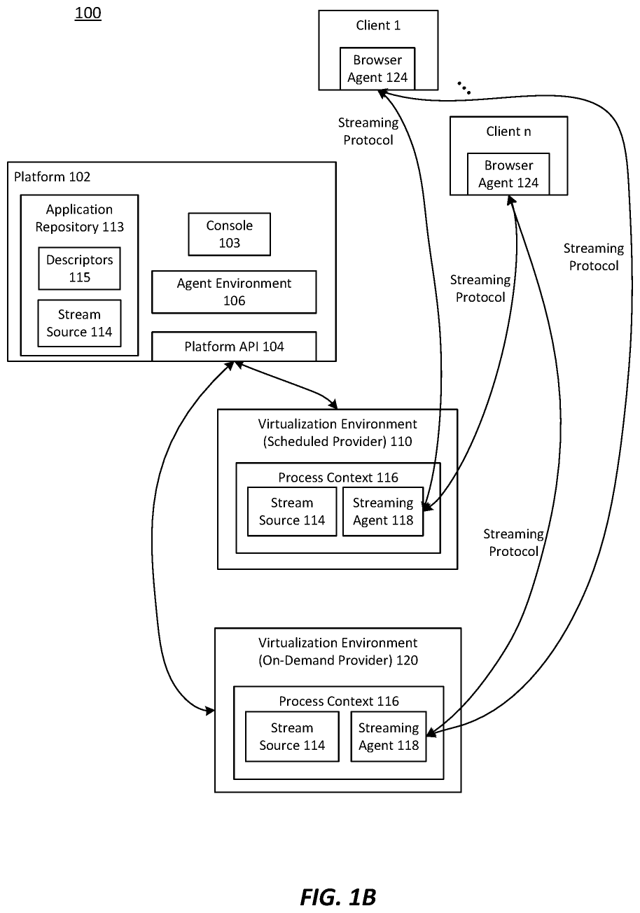

FIGS. 1A and 1B illustrate high-level functionalities and the entities in an example system architecture 100 in accordance with the present disclosure. FIG. 1A illustrates components that facilitate the uploading of a stream source. FIG. 1B illustrates components that facilitate the execution of a stream source in a runtime environment and the streaming of video, input events and messaging between a runtime environment and one or more clients.

A platform 102 provides an extensible foundation for building robust digital experiences. The platform 102 includes a platform API 104 that is the ‘edge’ to the outside world. Requests for platform services are authenticated and go through the API 104, which is used for, e.g., logging into the console 103 to publish/unpublish a stream source, to launch an a stream source via a Client 1 . . . Client n or to programmatically upload a stream source 114. The platform API 104 also provides a way for the platform 102 to convey stream source information and launch request information to virtualization environments 110/120.

The console 103 provides for self-service and is the user-facing experience for developers interacting with the platform 102. The console 103 provides mechanisms for user and organization management, creation of projects (a collection of agent processes/stream sources that share the same user/organization access controls, as well as the ability to associate specific custom external virtualization providers), stream source upload (e.g., a streaming game) to the platform 102, stream source scheduling and deployment, platform SDK download, developer documentation, usage reports, analytics and billing. For example, functionalities of the console 103 are accessible by users to provide a friendly, user-facing interface to those features. The platform SDK provides a set of tools to enable developers to interact with the platform 102.

Client 1 . . . Client n may include a custom client in which an Agent SDK may be provided as a TypeScript toolkit (or other) for building browser agent based applications. The client library provides mechanisms for making authenticated requests to launch streaming applications, decoding video, handling inputs, and interacting with an agent environment 106 (described below). The client library may be part of a client web application, which will typically be unique for each project. The platform 102 provides a preview client based on the client library which can be used for testing the functionality of the platform 102 and the client library itself.

An application repository 113 is a data store for the platform 102 and includes the stream sources 114 to be executed in a virtualization environment (e.g., a streaming game) and associated descriptors 115 that include items such as users, organizations, projects, deployment details, and agent environment keys (i.e., metadata associated with the stream source 114). Descriptors 115 provide information about the stream source 114, such as its name, ID, and its relationship to a user, project, organization etc. Descriptors 115 also describe one or more version configurations that detail the version id, the canonical file location for the version, as well as any custom runtime arguments and/or environment variables for the version. Version configurations can be changed/updated transparently, even while stream sources 114 execute within a virtualization environment(s). As shown in FIGS. 1A and 1B, the stream source 114 within the platform 102 is at rest.

As a non-limiting example, the descriptors 115 in the application repository 113 may contain information that a given user is a member of a particular organization associated with the stream source 114. The descriptors 115 contains all of the agent environment keys that the given user has created which are encoded therein. In another non-limiting example, the descriptors 115 in the application repository 113 may contain information that the given user has uploaded three different versions of a 3D gaming stream source 114 called, e.g., ‘EauClaire’, and it would know where to find these stream sources in the application repository 113. The EauClaire stream source 114 would have information that the given user has requested that it be deployed to, e.g., predetermined geographical regions of the virtualization environment 110/120. The application repository 115 may further include billing and analytics data.

The agent environment 106 is a common reference point around which agents, using an Agent SDK, can coordinate their activity. An agent “joins” the agent environment 106, which is a meeting place for all agents participating in a peered relationship. The streaming agent 118 and the browser agent 124 use the agent environment 106 to coordinate the signaling information necessary to start a stream. However, the agents could also use the same agent environment 106 to exchange any other type of non-streaming data as well. In an example context of providing a streaming enabled game or other application as a stream source 114, both the browser agent 124 and streaming agent 118 would meet (“join”) in the agent environment 106 as shown in FIG. 1A to coordinate signaling data to establish a direct peer-to-peer connection using a streaming protocol, e.g., WebRTC, as shown in FIG. 1B. Other protocols and data may be streamed between agents in FIG. 1B, such as Geometry Pump Engine Group (GPEG), virtual reality (VR) data such as CloudXR or OpenVR, as the architecture 100 is protocol agnostic.

A virtualization environment, in accordance with the present disclosure, is any environment in which stream sources and their associated agents are executed. The virtualization environment is a place to run agents and may be provided within a cloud infrastructure. In the example environment of FIGS. 1A and 1B, the virtualization environment 110 may be responsible for receiving scheduled deployment requests in a cloud infrastructure, thereby insuring that a given stream source is available to be run in a specified region. Specific regions may be scheduled to reduce latency associated with the execution of stream sources at a trade-off of higher costs, for example. The virtualization environment 120 may provide generic pooled servers in a cloud infrastructure for on-demand deployment requests. The generic pooled servers may be used to reduce costs and improve application availability on an as-needed basis.

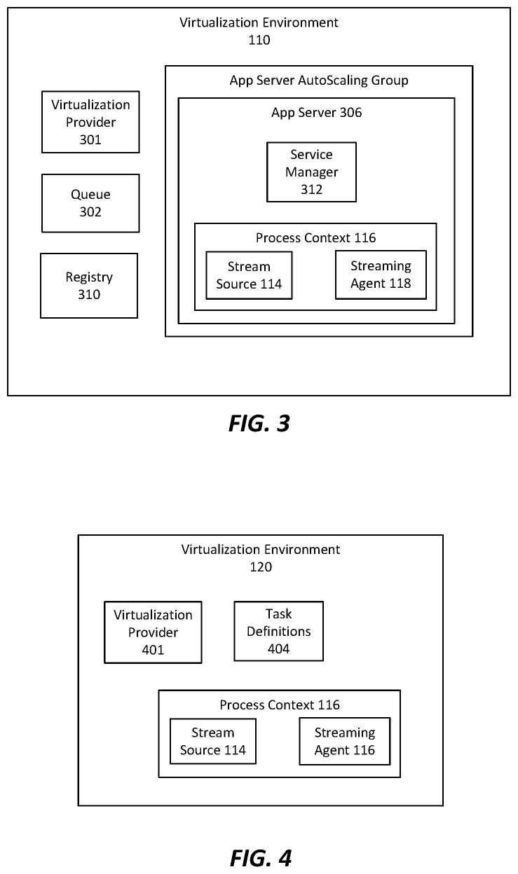

In some instances stream sources and their associated agents may be executed within a non-virtualized, physical computing devices to operate collaboratively to share data. More details are described below with reference to FIGS. 3, 4 and 7. Thus, the platform 102 can make choices about which virtualization environment(s) to use to serve the requirements of the particular stream source 114. The virtualization environments, whatever they may be, will convey information to the platform 102 as to whether they can serve a particular stream source 114.

Each virtualization environment provides a process context 116 in which the stream sources 114 execute. With particular reference to FIG. 1B, streaming data associated with the stream sources 114 is communicated by an associated streaming agent 118 to one or more browser agent(s) 124 executing on one or more of the connected Client 1 . . . Client n in a peer-to-peer fashion. In some implementations, the stream source 114 executes in the process context 116. Video, messages and notifications are communicated over the peer-to-peer connection. Additional details of all of the above are provided with reference to FIGS. 3-4.

In addition to the components shown and described above, the platform 102 may optimize the selection of virtualization environments based on certain criteria (e.g., latency) and provide “hints” to various virtualization environments as to why it may be underperforming so the virtualization environments may optimize resources to better serve launch requests. Thus, the above provides for an architecture 100 for connecting and massively scaling agents to provide interactive real-time application and an environment for creating novel end-user solutions that would otherwise not be possible in conventional environments.

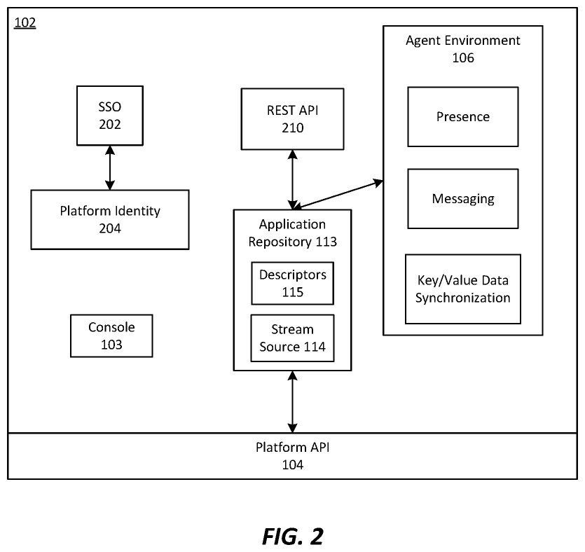

With reference to FIG. 2, there is illustrated the platform 102 of FIGS. 1A and 1B in greater detail. As shown, the platform 102 includes a single sign-on mechanism 202 that communicates with a platform identity 204 to perform authentication with identity providers or using a conventional username and password. Once authenticated, users can make requests for various platform APIs, and the platform identity 202 will grant a limited scope to accomplish that task.

The agent environment 106 provides a mechanism for agents (for example, streaming agents 118 and browser agents 124) to subscribe to notifications from other agents, send messages to one another, and share data in a synchronized key/value. The agent environment 106 provides real-time data synchronization services, messaging mechanisms, as well as other services, to enable the agents to achieve any number of peer-to-peer scenarios and with bidirectional data flows.

The application repository 113 maintains “canonical stream source binaries” or source of truth for all stream sources 114 and configurations in the descriptors 115. The stream source binaries and configurations may be replicated out of the application repository 113 into the various virtualization environments for execution. The application repository 113 may also hold references to versioned zip files in a storage service. The application repository 113 may maintain references to all the different executables, as well as the information necessary where to deploy and run those executables. The application repository 113 will also be where users upload their stream sources 114 to, when using the developer console 103.

The application repository 113 enables the platform 102 to maintain the source of truth for what should be published/unpublished. For example, changes to the status of a stream source 114 may be monitored within various virtualization environments, and that publication status may be consumed and propagated into virtualization environments, as needed. In particular, publication may be handled by the virtualization environment 110/120, which will watch for changes in the API endpoint. If a change is made to “publish” or “unpublish” a stream source 114, the virtualization environment 110/120 will update the status for that application. “Published” from the point of view of the virtualization environment simply means that an entry exists in the virtualization environment registry for the given projectId:modelId:version. This above may take place over a secure WebSocket API abstraction.

With reference to FIGS. 3 and 4, there is illustrated additional details of the virtualization environment 110 (for scheduled deployment requests) and the virtualization environment 120 (for on-demand deployments). Generally, the virtualization environments abstract the details of where the stream sources are running. Virtualization providers 301/401 within the virtualization environments 110/120 provide virtualization services to the platform 102 in order to execute stream sources 114. Differing and unlimited virtualization environments 110/120 (e.g., VMs in GCP, Containers in AWS (EKS)) or non-virtualized environments may be accommodated (e.g., desktop/laptop computers, appliances, smartphones, IoT devices, private datacenters, etc.) so long as the virtualization environments or non-virtualized environments have a virtualization provider that can connect to the platform 102. This aspect of the present disclosure enables the architecture 100 to scale up or down as-needed to accommodate the resource needs of stream sources in a way that conventional systems cannot.

In an example with regard to virtualization provider 301. requests by a Client 1 . . . Client n (using, e.g., the client library) to launch a stream source are made by calling the API interface 104 on the platform 102, which makes an API call to the virtualization provider 301, which puts the stream source into a queue 302. A registry 310 is an ephemeral datastore that maintains precise records about what stream sources at what versions are available on what servers within the virtualization environment 121 at any given moment. The registry 310 provides a snapshot of capacity and utilization for the virtualization provider 301 allowing the virtualization provider 301 to make appropriate scheduling choices. Requests to update stream sources are made by the virtualization provider 301 in the registry 310 so all hosting service managers 312 can then update themselves with the latest stream source 114.

The platform 102 updates the launch request status as it passes through different parts of a queuing process. For some launch requests, the platform 102 knows the executable path and any custom command line parameters or environment variables specified by the console user, as such, those values may be included in a launch request so that the virtualization provider 301 can run the requested process. The virtualization provider 301 then dispatches the requests to a server capable of handling the request (e.g., app server 306 and its associated process context 116) to run the stream source 114 in accordance with information in its descriptors 115. This way, the platform 102 can share knowledge that the virtualization provider 301 needs to know about the stream source 114 in order to run that stream source 114 in the virtualization environment 110. Virtualization provider 401 may provide similar services in the virtualization environment 120

Each virtualization environment 110/120 may have one or more virtualization providers 301/401 that each communicate with the platform 102. In the architecture 100, the virtualization provider 301/401 may be responsible for the following functionalities:
Registering with the platform 102 using the platform API 104 when the virtualization environment comes online.
   This may include querying for the initialization state (how should the virtualization environment should configure itself).
   “registration” may include the virtualization environment informing the platform 102 a) what region it is in, and b) what the API endpoint for the virtualization provider will be.
   Registration may also include any special traits about the virtualization environment (e.g., is it for a dedicated customer), where is it hosted, (on premises, GCP, etc.), and other traits.
Deregistering its virtualization environment from the platform 102.
Providing (or pushing) updates to the platform about virtualization environment utilization/app caching status.
   This will allow the sorting hat in the platform to make the best decision about where to route launch requests.
Accepting launch requests and pre-launch hints from the platform 102 on behalf of the virtualization environment (as well as updating the platform on the progress of those status requests).
Launch request dispatching.

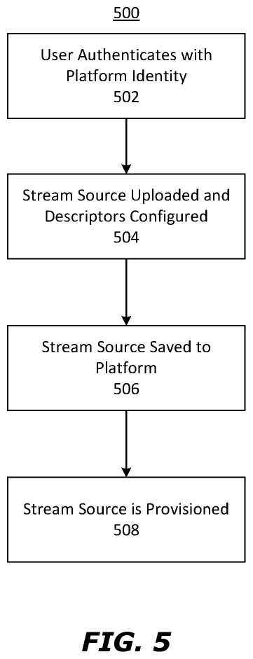

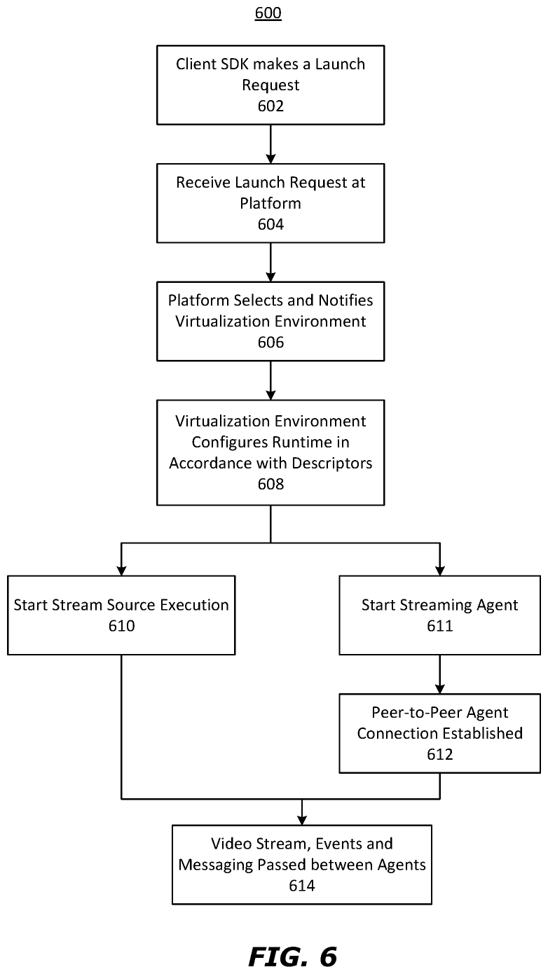

FIGS. 5-6 illustrates operation flows within the architecture 100. FIG. 5 illustrates the processes 500 performed in uploading a stream source. At 502, a user authenticates with the platform identity. The user authenticates using the single sign-on mechanism 202 that communicates with a platform identity 204 to perform authentication to services through third party sources or using a username/password combination. At 504, a stream source is uploaded and its associated descriptors are configured. One authenticated, the user logs into the console 103 to programmatically upload the stream source 114. At 506, the stream source is saved to the platform. The stream source 114 may be saved to the application repository 113 together with its associated descriptors 114. Thereafter, at 508, the stream source is provisioned by the platform. The stream source binary is replicated from the application repository 113 in the platform 102 to virtualization provider(s) specified in its descriptors 115.

FIG. 6 illustrates the processes 600 launching a stream source that is registered to platform. At 602, the client SDK makes a launch request. At 604, the launch request is received at the platform. At 604, the platform notifies a selected virtualization environment of the launch request and provides stream source descriptors to the virtualization environment. In so doing, the platform makes a selection of the virtualization environment based on selection process using predetermined criteria, such as selecting a closest virtualization environment (i.e., lowest latency). Other criteria may be considered, such as resource availability, cost, self-hosted environment, geographic location, wait time to instantiate a container, etc. Feedback of a virtualization environment's performance may be factored into the selection process, where poorly performing environments are given a lower priority than better performing environments.

At 608, virtualization environment configures its runtime in accordance with the descriptors to enable the execution of the stream source. The descriptors provide information about the stream source 114, such as its name, ID, and its relationship to a user, project, organization, any custom runtime arguments and/or environment variables, etc. to the virtualization provider. The platform 102 will update a launch request status as it passes through different parts of a queuing process. For some launch requests, the platform 102 knows the executable path and any custom command line parameters or environment variables specified by the console user, as such, those values may be included in a launch request so that the virtualization provider can run the requested process.

The launch request results in two processes, where the virtualization environment executes the stream source in the process context at 610 and starts is associated streaming agent in the process context at 611. At 612, a peer-to-peer agent connection is established. The peer-to-peer connection is between the streaming agent 118 and one or more browser agents 124. At 614, a video stream, events and/or messaging is communicated between the agents over the peer-to-peer connection. Rendered frames created by the stream source 114 are provided to its associated streaming agent 118 and communicate to one or more connected browser agents 124.

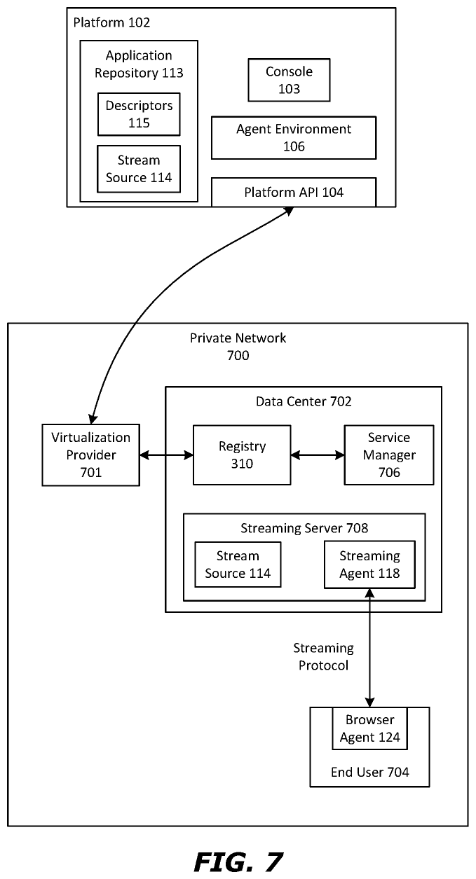

With reference to FIG. 7, the present disclosure contemplates different types of virtualization environments through its unique decoupling mechanisms. These different scenarios may be variations of cross-cloud or hybrid-cloud solutions. In one implementation, the virtualization environment may be run in an end-user's own self-managed private network 700 that includes an on-premises data center 702. In this implementation, other components of the platform 102 remain the same and the end-user's virtualization provider 701 provides virtualization services to the platform 102. In this example, the virtualization provider 701 communicates with the registry 310 and service manager 706 in a data center 702. The data center 702 includes a streaming server 708 that provides a process context for the stream source 114 and streaming agent 118. An end-user device 704 executes the browser agent 124 that is in communication with the streaming agent 118. In this example, the core platform functionalities remain in the platform 102, which would act as a broker for all requests within the customer's private network 700.

### Example Implementation—Streaming Games

In an implementation, the stream sources running in the virtualization environment(s) may be a streaming game, e.g., using Unreal or Unity game engines, and including “enterprise games” such as product configurators, training simulators, virtual events, architectural/engineering/construction models, etc. In order for these games to interact with all the various platform services, they include engine-specific platform plugins, each of which is built on top of a library. For example, the plugin may be a game-specific streaming plugin or a WebRTC Framework.

For example, the architecture enables a 3D application, such as a streaming game, to be more easily integrated with third party data sources and streamed to the web browser without the need for a custom plugin (e.g., a car configurator integrating with an ERP system). A more involved scenario would be one where fully autonomous agents which lack any sort of rendering capabilities can meet to achieve some sort of objective. For example, a system that is collecting a variety of IoT data from the real world, such as a mesh of chemical, water, and infrared sensors deployed at a reclaimed oil and gas well site being used to measure the progress of site reclamation. If an agent based system was responsible for aggregating that data, that agent could invite a machine-learning peer agent running in a container in a virtualization environment to a shared agent environment where the ML agent could process the data and identify any relevant trends and notify stakeholders. It is contemplated that using the architecture of the present disclosure, any software system can be an agent, and any agent that needs a home can run in an appropriate virtualization environment.

Thus, the system architecture described herein solves many limitations in the art, including, but not limited to how to provide protocol agnostic, real-time interactive stream sources, at scale in a way that allows for those services to be easily connected to third party applications, services and data; how to provide self-service facilities for end users to upload and publish streaming applications in a globally distributed fault-tolerant way; and how to dynamically manage and optimize infrastructure costs and streaming application availability in a multi-tenant streaming platform.

What is claimed:

1. A platform for scaling peer-based agents, comprising:
a platform API through which all interactions with the platform flow and are authenticated;
a console to which clients connect through the platform API to interact with the platform;
an application repository that stores stream sources and descriptors, the descriptors providing information about how to run the steam sources in one or more virtualization environments; and
an agent environment that provides a mechanism for one or more agents to determine from published information about other agents, which of the other agents the one or more agents want to peer with to communicate stream source data therebetween using peer-to-peer connections,
whereby the platform communicates to one or more virtualization providers that are responsible for computing infrastructure within the one or more virtualization environments to scale resources in accordance with requirements of the stream sources.

2. The platform of claim 1, wherein the agents connected to the agent environment coordinate signaling information to start the peer-to-peer connection.

3. The platform of claim 2, wherein peered agents perform bi-directional synchronization of messages and event information.

4. The platform of claim 2, wherein streaming video is communicated over the peer-to-peer connection.

5. The platform of claim 1, wherein the stream sources and their associated descriptors are replicated from the application repository to the one or more virtualization environments, and wherein the virtualization providers abstract the details of the one or more virtualization environments from the platform.

6. The platform of claim 5, wherein the clients connect to the console using a platform SDK to make requests to launch stream sources in the one or more virtualization environments.

7. The platform of claim 5, wherein the platform optimizes a selection of a particular virtualization environment to run the stream sources in accordance with predetermined criteria.

8. The platform of claim 7, wherein the predetermined criteria include latency, cost, a geographic location of the virtualization environment, and resource availability.

9. The platform of claim 1, wherein the platform API is adapted to receive API calls from the virtualization providers to register the one or more virtualization environments with the platform, and wherein the one or more virtualization environments have differing characteristics.

10. The platform of claim 1, further comprising a single sign-on mechanism that communicates with a platform identity component to perform the authentication.

11. A scalable, peer-to-peer based agent architecture, comprising:
a platform that interfaces to external entities using a platform API, the platform including an application repository that stores stream sources and associated descriptors, an agent environment and a developer console;
virtualization environments that each execute stream sources to produce output data,
wherein virtualization providers register the virtualization environments with the platform,
wherein the stream sources and associated descriptors are replicated from the platform to the virtualization environments;
wherein one or more agents connect to the agent environment and use published information about other agents to determine which of the other agents the one or more agents want to peer with, and
wherein peered agents communicate the output data therebetween using a peer-to-peer connection.

12. The architecture of claim 11, wherein the output data is streaming video and the peer-to-peer connection implements a streaming protocol.

13. The architecture of claim 11, wherein the platform further comprises a single sign-on mechanism that communicates with a platform identity component to perform the authentication.

14. The architecture of claim 11, wherein the agent environment provides a mechanism for the one or more agents to subscribe to notifications from each other, send messages to each other, and share data with each other.

15. The architecture of claim 14, wherein the one or more agents connected to the agent environment coordinate signaling information to start the peer-to-peer connection.

16. The architecture of claim 11, wherein the platform optimizes a selection of a particular one of the virtualization environments based on predetermined criteria.

17. The architecture of claim 16, wherein the predetermined criteria include latency, cost, a geographic location of the virtualization environment, and resource availability.

18. The architecture of claim 11, wherein the associated descriptors are used to configure the virtualization environments.

19. The architecture of claim 18, wherein the associated descriptors contain environmental variables and runtime arguments to execute the stream source.

20. The architecture of claim 11, wherein the application repository contains version information associated with the stream sources.

21. The architecture of claim 11, wherein a platform SDK provides a set of tools to enable users to interact with the console.

22. The architecture of claim 11, wherein a request is received at the console to launch a stream source at a specified one of the virtualization environments in the associated descriptors.

23. The architecture of claim 11, wherein the virtualization environments are any environment in which agents and their related processes are executed.

24. The architecture of claim 23, wherein the virtualization environments are one of a cloud-based infrastructure, an on-premises infrastructure, a private data center, a desktop computing device, a laptop computing device, a smart phone, an Internet appliance, and an Internet of Things (IoT) device.

25. The architecture of claim 23, wherein the virtualization environments convey information to the platform through the virtualization providers as to whether the virtualization environments can serve a particular stream source.

26. The architecture of claim 11, wherein the virtualization environments provides a process context in which the stream source and an associated agent execute to stream the output data to one or more second agents communicating with the associated agent over a respective peer-to-peer connection.

27. The architecture of claim 11, wherein virtualization providers within the virtualization environments provide virtualization services to the platform and abstract the details of the virtualization environment from the platform in order to execute the stream sources.

28. The architecture of claim 11, wherein virtualization providers register the virtualization environment with the platform to inform the platform what region the virtualization environments are in, provide utilization information to the platform, and accept requests to launch stream sources from the platform.

29. The architecture of claim 28, wherein the virtualization providers dispatch the request to launch the stream source to an available resource within the virtualization environment to execute the stream source and the associated agent.

30. The architecture of claim 11, wherein the agents perform data acquisition using the peer-to-peer connections, and
wherein the agents are associated with applications, browsers, services, and data sources in the architecture.

31. A method for providing scalable, peer-to-peer based streaming between agents, comprising:
receiving a stream source uploaded to a console of a platform from an authenticated user;
saving the stream source to an application repository together with descriptor information associated with the stream source;
provisioning the stream source by replicating the stream source and descriptor information to at least one virtualization environment specified by the descriptors and registered with the platform by an associated virtualization provider;
subsequently, receiving a request at the platform to launch the stream source;
executing a first process in the at least one virtualization environment to run the stream source;
executing a second process in the at least one virtualization environment to run an agent associated with the stream source; and
streaming data from the agent to a second agent over a peer-to-peer connection to exchange data and messaging therebetween.

32. The method of claim 31, further comprising selecting the virtualization environment based predetermined performance criteria or the descriptor information.

33. The method of claim 32, wherein the performance criteria comprises such as resource availability, cost, whether the virtualization environment is a self-hosted environment, geographic location, wait time to instantiate a runtime environment.

34. The method of claim 31, further comprising providing an agent environment in the platform to which the agents connect and use published information about other agents to determine which of the other agents to peer with.

35. The method of claim 31, further comprising:
providing the at least one virtualization environment as any environment in which agents and their related processes are executed, wherein the at least one virtualization environment is one of a cloud-based infrastructure, an on-premises infrastructure, a private data center, a desktop computing device, a laptop computing device, a smart phone, an Internet appliance, and an Internet of Things (IoT) device.

36. The method of claim 35, further comprising conveying, by the associated virtualization provider, information from the virtualization environment to the platform as to whether the virtualization environment can serve the stream source.

37. The method of claim 31, further comprising providing at least one virtualization provider within the virtualization environment to abstract details of the virtualization environment from the platform and to facilitate in executing the stream source.
